(19) United States
(12) Patent Application Publication
(10) Pub. No.: US 2012/0190258 A1
(43) Pub. Date: Jul. 26, 2012

(54) FIBROUS PART AND MOLDED PART

(75) Inventor: Josef Glaser, Helfenberg (AT)

(73) Assignee: Helfenberger Immobilien LLC & Co Textiforschungs - ung Entwicklungs KG, Helfenberg (AT)

(21) Appl. No.: 13/390,762

(22) PCT Filed: Aug. 12, 2010
(86) PCT No.: PCT/AT2010/000298

§ 371 Date: Apr. 12, 2012

(30) Foreign Application Priority Data
Aug. 20, 2009 (AT) A 1314/2009

(51) Int. Cl. B32B 5/06; B29C 49/08; D02J 1/22

(52) U.S. Cl. 442/270; 442/388; 264/103; 264/500

(57) ABSTRACT

A non-woven fabric (1) modified by activated carbon is needled onto an elastic or inelastic textile sheet material (2), preferably a woven fabric or a knitted fabric. By this method, the strength of the textile sheet material (2) can be imparted to a non-woven fabric (1) that is otherwise not tear-resistant, wherein the adsorption properties of the activated carbon necessary for protective textiles are completely retained. The elastic or inelastic textile sheet material (2) is stretched or retained stretched while the non-woven fabric is needled on and is relaxed after the non-woven fabric has been needled on. The effect thereby achieved is that the non-woven fabric (1) does not tear if the textile good or the molded part is stretched again, because the non-woven fabric is then stretched from a compressed initial state.

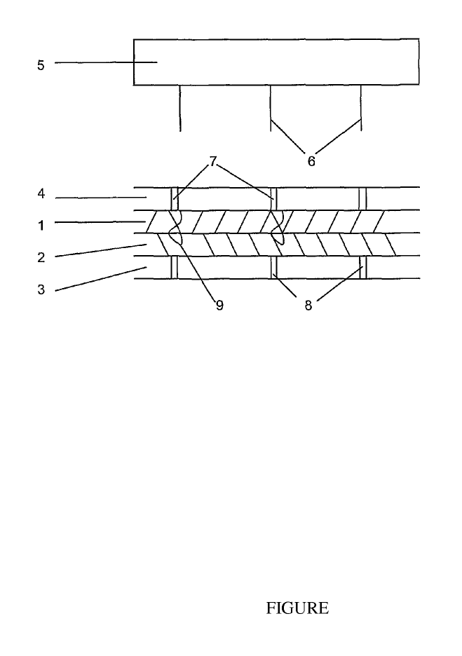

The invention relates to a method for producing a textile good or a molded part from a non-woven fabric that is modified with activated carbon.

In addition, the invention relates to a textile good.

Moreover, the invention relates to a molded part.

In contrast to woven fabrics (textiles) and knitted fabrics (e.g., knit fabric or mesh), which are produced from yarns, a non-woven fabric is a textile sheet material that consists of individual, loosely interlaced fibers or filaments. The strength of a non-woven fabric is essentially based on the adhesion inherent in the fiber, which is why a non-woven fabric quickly tears when it is stretched.

It is known to use non-woven fabrics made of fibers in which at least the surface layer has activated carbon—because of the adsorption properties of the activated carbon—as protective textiles. Such fibers have a proportion of activated carbon of approximately 30 to 50%. In this case, it is disadvantageous that such a proportion of activated carbon further reduces the tear resistance of a non-woven fabric. If the activated carbon content is reduced (e.g., to approximately 20% or less), the tear resistance of the non-woven fabric is not further reduced but the adsorption properties of the activated carbon are lost to such an extent that the non-woven fabric can no longer be used for protective textiles.

From the state of the art, it is further known that non-woven fabrics that consist of very fine fibers are combined as filter materials (air, liquid, particle filtration) with other non-woven fabrics to increase the strength. It is thus achieved that the thickness of the filter layer that consists of non-woven fabric is increased in such a way that the forces that act essentially perpendicular to the non-woven fabric layer during filtering do not as quickly break through the filter layer. Such permanent forces that act essentially perpendicular to the non-woven fabric layer are not comparable, however, with a stretching of the non-woven fabric layer, in which forces are exerted in any possible direction on the non-woven fabric. In a stretching of the thus combined non-woven fabric layer, in addition the above-mentioned drawbacks with respect to the tear resistance occur. Moreover, it is important in uses of the invention (e.g., protective clothing, such as protective gloves) that the layer thickness of the non-woven fabric is not especially increased, since otherwise the freedom of movement of an individual who is wearing the textile good according to the invention is limited, which represents a significant safety risk.

The object of the invention is to make available a method of the above-mentioned type as well as a textile good and a molded part, with which the drawbacks of the state of the art are avoided to a very large extent.

This object is achieved according to the invention with a method that has the features of claim 1.

As far as the textile good is concerned, this object is achieved with a textile good with the features of claim 9.

As far as the molded part is concerned, this object is achieved with a molded part with the features of claim 10.

Preferred and advantageous embodiments of the invention are subjects of the subclaims.

According to the invention, it is provided that a non-woven fabric that is modified with activated carbon is needled on an elastic or inelastic textile sheet material, preferably a woven fabric or a knitted fabric. With this method, it is achieved that the strength of the textile sheet material, in particular the woven fabric or knitted fabric, can be imparted to a non-woven fabric that is otherwise not tear-resistant, whereby the layer thickness of the textile good remains low and the adsorption properties of the activated carbon that are necessary in protective textiles are completely retained.

Within the scope of the invention, the non-woven fabric that is modified with activated carbon can be produced as follows:

In the example of a lyocell method (N-methylmorpholine N-oxide, NMMNO), approximately 30 to 50% activated carbon can be admixed for the production of a non-woven fabric fiber of the dissolved cellulose. Also, known wet spinning methods can be applied within the scope of the invention, in which, for example, activated carbon is admixed in the spinning bath. Below, the formation of cellulose-spunbonded non-woven fabrics according to the meltblown method is discussed.

The meltblown method primarily allows the production of a non-woven fabric from the finest fibers, with economic parameters, which is why the thus-produced non-woven fabrics are especially advantageous because of their smallest possible layer thickness for protective textiles. However, the above-mentioned drawback of the low tear resistance because of the especially fine fibers in the meltblown non-woven fabrics is especially pronounced.

The cellulose/NMMO spinning solution that has activated carbon passes through a spinning pump into a spinning nozzle, which has nozzle bores that are uniformly distributed over the entire spinning width. The spinning solution is forced through the nozzle and formed into cellulose-extrudate strands, which in the meltblown method are picked up by relatively cold air blasts, stretched and twisted into continuous fibers. A spraying of the fibers with water and/or air that takes place directly under the spinning nozzle produces the coagulation of the formed cellulose/NMMO solution jet. The cellulose fibers that are produced are then plaited into a non-woven fabric, washed to remove solvents, and solidified and dried to form a cellulose-spunbonded non-woven fabric.

For needling, the non-woven fabric that is modified with activated carbon is arranged on the textile sheet material. Then, non-woven fabric and textile sheet materials are arranged between a base plate and an (optional) holding-down plate and fed to a needle device. The base plate and holding-down plate are designed as perforated disks, whereby the arrangement of the holes corresponds to the arrangement of the needles in the needle device.

When the needles penetrate (or puncture) the non-woven fabric and the textile sheet material, a portion of the fibers or filaments of the non-woven fabric is reoriented in the form of fiber loops into a plane that is perpendicular to the textile sheet material. The tips of these fiber loops penetrate the textile sheet material or puncture the textile sheet material and remain outside of the non-woven fabric even after the needles are pulled out.

Preferably, for needling the non-woven fabric, notched needles are used on the textile sheet material.

In an especially preferred embodiment of the invention, it is provided that the elastic or inelastic textile sheet material is stretched or is kept stretched during needling and that stress is relieved after needling. The effect that is thus achieved is that the non-woven fabric does not tear when the textile good or the molded part is stretched again, since the non-woven fabric is then stretched out from a compressed initial state.

Since a textile (woven fabric) in comparison to a mesh or knit fabric (knitted fabric) has a lower elasticity, the stretching is carried out during needling, preferably with a knitted fabric.

Other details, features and advantages of the invention follow from the description below with reference to the attached drawing, in which a preferred embodiment is depicted.

A non-woven fabric 1 is applied on an elastic or inelastic textile sheet material 2 for the production of a textile good or a molded part. Non-woven fabric 1 and textile sheet material 2 are arranged between a base plate 3 and a holding-down plate 4 and fed to a needle device 5. Needles 6 execute a vertical up-and-down motion in the needle device 5. The base plate 3 and the holding-down plate 4 have holes 7, 8, through which the needles 8 of the needle device 5 go during needling. In the downward motion of the needles 8, the non-woven fabric 1 and the textile sheet material 2 are pressed against the base plate 3. In the upward motion of the needles 8, the non-woven fabric 1 and the textile sheet material 2 are held in position by the holding-down plate 4. By higher or lower positioning of the base plate 3, the penetration depth of the needles 8 in the non-woven fabric 1 and the textile sheet material 2 can be varied.

In the embodiment depicted in the figure, fiber loops 9 are formed from fibers of the non-woven fabric 1 by the needling, whereby the fiber loops 9 are arranged within the textile sheet material 2 after the upward motion of the needles 6.

During needling, the textile sheet material 2 is stretched. The textile sheet material 2 can also be stretched before the needling, whereby it is kept in the stretched state during needling. After needling, stress is relieved in the textile sheet material 2 or the textile good or the molded part that is produced.

The thus produced textile good or the molded part can be stretched, whereby the non-woven fabric (1) is needled in the unstretched state of the textile good or the molded part in a compressed state on the elastic or inelastic textile sheet material (2).

1. Method for producing a textile good or a molded part from a non-woven fabric (1) that is modified with activated carbon, characterized in that the non-woven fabric (1) is needled on an elastic or inelastic textile sheet material (2).

2. Method according to claim 1, wherein a woven fabric or a knitted fabric is used as an elastic or inelastic textile sheet material (2).

3. Method according to claim 1, wherein a cellulose-spunbonded non-woven fabric that is modified with activated carbon is used as non-woven fabric (1).

4. Method according to claim 3, wherein a spinning solution with a cellulose concentration of 6% is used for producing the non-woven fabric (1).

5. Method according to claim 3, wherein a spinning solution with an activated carbon concentration of 30% to 50% relative to cellulose is used for producing the non-woven fabric (1).

6. Method according to claim 1, wherein the non-woven fabric (1) is produced by a meltblown method.

7. Method according to claim 2, wherein a mesh or a knit fabric is used as knitted fabric.

8. Method according to claim 1, wherein the elastic or inelastic textile sheet material (2) is stretched or kept stretched during needling, and stress is relieved after needling.

9. Textile good, characterized by a non-woven fabric (1) that is modified with activated carbon and that is needled on an elastic or inelastic textile sheet material (2).

10. Molded part, characterized by a non-woven fabric (1) that is modified with activated carbon and that is needled on an elastic or inelastic textile sheet material (2).

11. Textile good or molded part according to claim 9, wherein the elastic or inelastic textile sheet material (2) is a woven fabric or a knitted fabric.

12. Textile good or molded part according to claim 9, wherein the textile good or the molded part can be stretched and wherein the non-woven fabric (1) in the unstretched state of the textile good or the molded part in a compressed state is needled on the elastic or inelastic textile sheet material (2).

13. Method according to claim 2, wherein a cellulose-spunbonded non-woven fabric that is modified with activated carbon is used as non-woven fabric (1).

14. Method according to claim 4, wherein a spinning solution with an activated carbon concentration of 30% to 50% relative to cellulose is used for producing the non-woven fabric (1).

15. Textile good or molded part according to claim 10, wherein the elastic or inelastic textile sheet material (2) is a woven fabric or a knitted fabric.
